(19) United States
(12) Patent Application Publication
(10) Pub. No.: US 2026/0353403 A1
(43) Pub. Date: Nov. 5, 2026

(54) ARTIFICIAL INTELLIGENCE-NATIVE RADIO RESOURCE CONTROL PROFILE ADAPTATION FOR USER EQUIPMENT

(71) Applicant: QUALCOMM Incorporated, San Diego, CA (US)

(72) Inventors: Tommy AZZINO, Jersey City, NJ (US); Ahmed BEDEWY, Hillsborough, NJ (US); Navid ABEDINI, Basking Ridge, NJ (US); Tao LUO, San Diego, CA (US); Junyi LI, Greentown, PA (US)

(21) Appl. No.: 19/661,440

(22) Filed: Apr. 28, 2026

Related U.S. Application Data
(60) Provisional application No. 63/798,213, filed on May 1, 2025.

(51) Int. Cl. H04W 72/231

(52) U.S. Cl. CPC H04W 72/231

(57) ABSTRACT

This disclosure provides methods, components, devices and systems for artificial intelligence (AI)-native radio resource control (RRC) profile adaptation for user equipment (UE). For example, a UE may receive configuration information that includes a plurality of RRC configuration profiles for the UE, wherein each RRC configuration profile of the plurality of RRC configuration profiles comprises respective parameter information, and wherein each RRC configuration profile corresponds to a respective communication scenario of one or more communication scenarios. The UE may transmit a requested RRC configuration profile that is different from each RRC configuration profile of the plurality of RRC configuration profiles, wherein the requested RRC configuration profile comprises requested parameter information for a particular communication scenario of the one or more communication scenarios. The UE may perform wireless communication associated with the particular communication scenario.

### CROSS REFERENCE

This Patent Application claims the benefit of U.S. Provisional Patent Application No. 63/798,213 by AZZINO et al., entitled “ARTIFICIAL INTELLIGENCE-NATIVE RADIO RESOURCE CONTROL PROFILE ADAPTATION FOR USER EQUIPMENT,” filed May 1, 2025, assigned to the assignee hereof. U.S. Provisional Patent Application No. 63/798,213 is expressly incorporated by reference herein in its entirety.

### INTRODUCTION

This disclosure relates generally to wireless communication, and more specifically to systems, devices, methods, and techniques associated with artificial intelligence-native radio resource control profile adaptation for user equipment.

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication performed by a network entity is described. The method may include receiving configuration information that includes a set of multiple radio resource control (RRC) configuration profiles for the network entity, where each RRC configuration profile of the set of multiple RRC configuration profiles includes respective parameter information, and where each RRC configuration profile corresponds to a respective communication scenario of one or more communication scenarios, transmitting a requested RRC configuration profile that is different from each RRC configuration profile of the set of multiple RRC configuration profiles, where the requested RRC configuration profile includes requested parameter information for a particular communication scenario of the one or more communication scenarios, and performing wireless communication associated with the particular communication scenario.

A network entity is described. The network entity may include a processing system configured to receive configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios, transmit a requested RRC configuration profile that is different from each RRC configuration profile of the set of multiple RRC configuration profiles, where the requested RRC configuration profile includes requested parameter information for a particular communication scenario of the one or more communication scenarios, and perform wireless communication associated with the particular communication scenario.

Another network entity is described. The network entity may include means for receiving configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios, means for transmitting a requested RRC configuration profile that is different from each RRC configuration profile of the set of multiple RRC configuration profiles, where the requested RRC configuration profile includes requested parameter information for a particular communication scenario of the one or more communication scenarios, and means for performing wireless communication associated with the particular communication scenario.

A non-transitory computer-readable medium storing code is described. The code may include instructions executable by one or more processors to receive configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios, transmit a requested RRC configuration profile that is different from each RRC configuration profile of the set of multiple RRC configuration profiles, where the requested RRC configuration profile includes requested parameter information for a particular communication scenario of the one or more communication scenarios, and perform wireless communication associated with the particular communication scenario.

In some examples of the method, network entities, and non-transitory computer-readable medium described herein, transmitting the requested RRC configuration profile may include operations, features, means, or instructions for transmitting the requested RRC configuration profile during an initial access procedure of the network entity or during operation of the network entity in a connected mode.

In some examples of the method, network entities, and non-transitory computer-readable medium described herein, the requested RRC configuration profile may be included in a RACH message three (Msg3), a RACH message A (MsgA), or an RRC signal.

Some examples of the method, network entities, and non-transitory computer-readable medium described herein may further include operations, features, means, or instructions for receiving an acknowledgement/negative-acknowledgement (ACK/NACK) message that indicates the requested RRC configuration profile may be usable to perform the wireless communication.

A method for wireless communication performed by a network entity is described. The method may include transmitting configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios, receiving a requested RRC configuration profile that is different from each RRC configuration profile of the set of multiple RRC configuration profiles, where the requested RRC configuration profile includes requested parameter information for a particular communication scenario of the one or more communication scenarios, and performing wireless communication associated with the particular communication scenario.

A network entity is described. The network entity may include a processing system configured to transmit configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios, receive a requested RRC configuration profile that is different from each RRC configuration profile of the set of multiple RRC configuration profiles, where the requested RRC configuration profile includes requested parameter information for a particular communication scenario of the one or more communication scenarios, and perform wireless communication associated with the particular communication scenario.

Another network entity is described. The network entity may include means for transmitting configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios, means for receiving a requested RRC configuration profile that is different from each RRC configuration profile of the set of multiple RRC configuration profiles, where the requested RRC configuration profile includes requested parameter information for a particular communication scenario of the one or more communication scenarios, and means for performing wireless communication associated with the particular communication scenario.

A non-transitory computer-readable medium storing code is described. The code may include instructions executable by one or more processors to transmit configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios, receive a requested RRC configuration profile that is different from each RRC configuration profile of the set of multiple RRC configuration profiles, where the requested RRC configuration profile includes requested parameter information for a particular communication scenario of the one or more communication scenarios, and perform wireless communication associated with the particular communication scenario.

In some examples of the method, network entities, and non-transitory computer-readable medium described herein, receiving the requested RRC configuration profile may include operations, features, means, or instructions for receiving the requested RRC configuration profile during an initial access procedure associated with the network entity or during operations associated with a connected mode.

### BRIEF DESCRIPTION OF THE DRAWINGS

FIG. 1 shows an example of a wireless communication system.

FIG. 2 shows an example of a signaling diagram that supports artificial intelligence (AI)-native radio resource control (RRC) profile adaptation for user equipment (UE).

FIG. 3 shows an example of a diagram that supports AI-native RRC profile adaptation for UE.

FIG. 4 shows an example of a diagram that supports AI-native RRC profile adaptation for UE.

FIG. 5 shows a block diagram of a processing system that supports AI-native RRC profile adaptation for UE.

FIG. 6 shows a diagram of a system including a device that supports AI-native RRC profile adaptation for UE.

FIG. 7 shows a block diagram of a processing system that supports AI-native RRC profile adaptation for UE.

FIG. 8 shows a diagram of a system including a device that supports AI-native RRC profile adaptation for UE.

FIGS. 9 and 10 show flowcharts illustrating methods that support AI-native RRC profile adaptation for UE.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, the network may configure one or more radio resource control (RRC) configuration profiles for user equipment (UE). The wireless communication systems may provide a mechanism for parameter(s) of the RRC configuration profiles to be configured, (de)activated, adopted, adapted, and the like, via lower-layer signaling, for example. The configured RRC configuration profiles may be associated with a particular purpose and/or communication scenario, such as for secondary cell(s) (SCell)(s), bandwidth part(s) (BWP)(s), a cell discontinuous transmission/discontinuous reception (DTX/DRX) mode, on-demand synchronization signal block (SSB) transmission for a SCell, and the like. However, such techniques generally include unique and specialized procedures that are applied to update each type of RRC configuration profile. That is, the procedures for updating the parameters for an RRC configuration profile related to SCell activation/deactivation are different from the procedures for updating the parameters for an RRC configuration profile related to on-demand SSB transmissions from a SCell. Moreover, such update techniques are generally limited to RRC signaling, which requires the UE to be operating in an RRC connected mode to update the RRC configuration profile.

Aspects of the subject matter described in this disclosure relate to a unified and future-proof framework for (re)configuration and/or adaptation of the RRC configuration profiles configured for a UE. For example, the described techniques may support a common framework for dynamic adaptation (e.g., via lower-layer signaling and/or event-triggered) of and/across one or multiple RRC configuration profiles. In some cases, this may include the network entity transmitting (and the UE receiving) configuration information that includes a plurality of RRC configuration profiles for the UE (which may be referred to as a network entity in some examples). Generally, each RRC configuration profile may include respective parameter information (e.g., the various parameters, settings, allocations, values, and the like) for the RRC configuration profile. In some cases, each RRC configuration profile may correspond to a respective communication scenario (e.g., overheating, SCell activation, BWP switching, an expected traffic pattern, etc.) of one or more communication scenarios.

The UE may transmit (and the network entity may receive) a requested RRC configuration profile that is different from each RRC configuration profile of the plurality of RRC configuration profiles. For example, the requested RRC configuration profile may include parameter information for a particular communication scenario. The UE may transmit the request for the requested RRC configuration profile while the UE is operating in a RRC connected mode and/or during an initial access procedure. In some cases, the UE may support a native artificial intelligence (AI) or other learning model that manages aspects of the RRC configuration profile updates. The UE and the network entity may perform wireless communication associated with the particular communication scenario (e.g., based on the requested RRC configuration profile, when adopted or otherwise accepted for use by the network).

Particular aspects of the subject matter described in this disclosure can be implemented to realize one or more of the following potential advantages. In some examples, by allowing the UE to signal the requested RRC configuration profile, the described techniques can be used to enable dynamic updates to the RRC configuration profiles configured for the UE (e.g., in response to various conditions and/or triggering events). By allowing the UE to transmit the indication of the requested RRC configuration profile while in the connected mode and/or during an initial access procedure, this may reduce the latency associated with RRC configuration profile updates and improve wireless communication between the UE and the network entity.

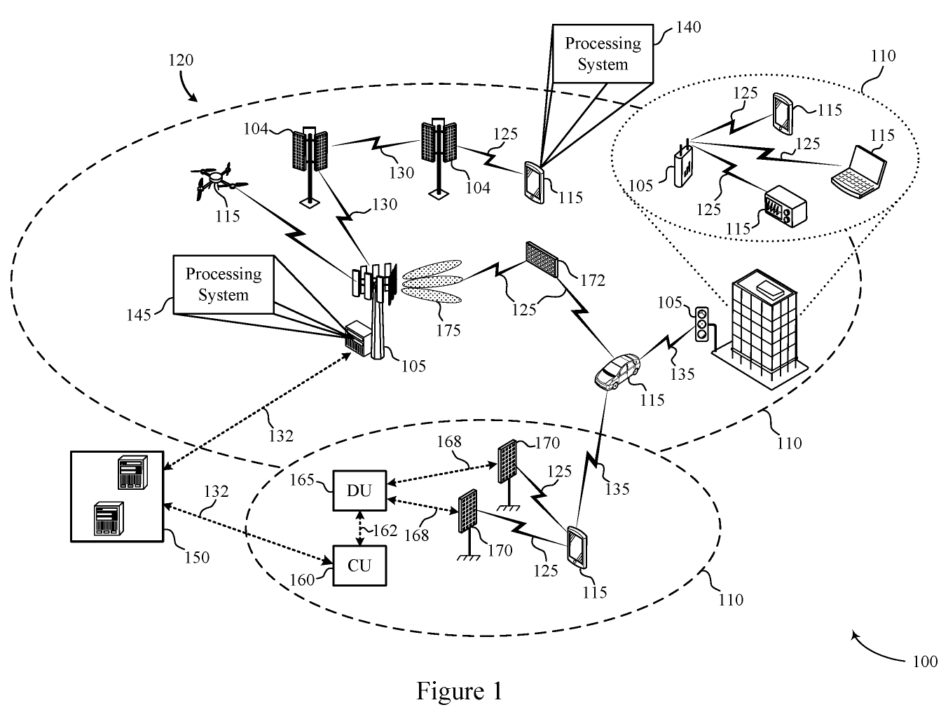

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 145. Similarly, the network entity (e.g., UE 115) may include a processing system 140. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425MHz and 7.125GHz), a mid-band (such as Frequency Range 3 (FR3), between 7.125GHz and 24.25GHz), or an upper frequency band (such as Frequency Range 2 (FR2), between 24.25GHz and 71GHz). Communication in the upper frequency band may be referred to as millimeter wave (mmW) communication, and communication above an upper frequency band (such as between mmW and THz frequencies, between 100GHz and 1THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for AI-native RRC profile adaptation for UE. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 may support dynamic RRC configuration profile updates based on AI-native UE implementations to reduce RRC configuration profile update latency and improve synchronization between the UE and the network entity.

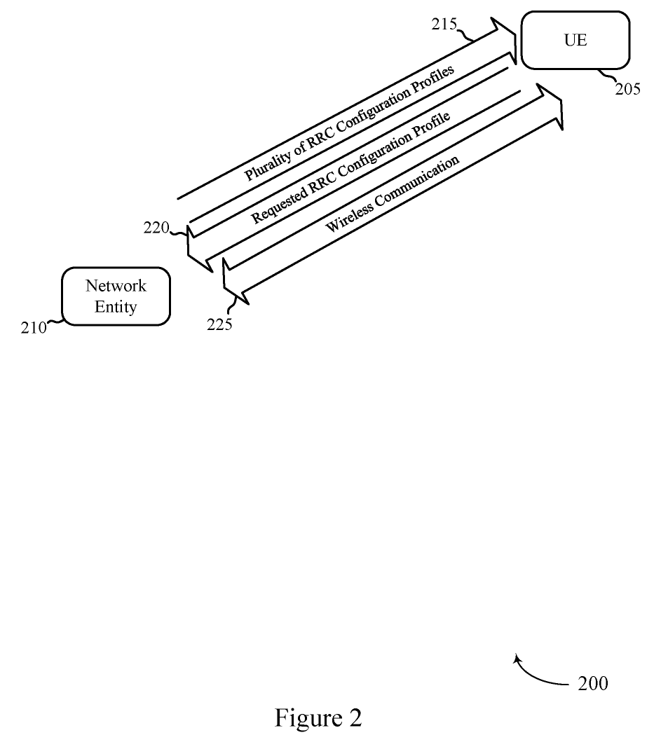

FIG. 2 shows an example of a signaling diagram 200 that supports AI-native RRC profile adaptation for UE. Aspects of the signaling diagram 200 may implement aspects of and/or be implemented by aspects of the wireless communication system 100. Aspects of the signaling diagram 200 may be implemented at or implemented by a UE 205 and/or a network entity 210, which may be examples of the corresponding devices described herein. In some cases, the UE 205 may also be referred to as a network entity.

Some wireless networks may use RRC signaling to configure RRC configuration profiles for UE. For example, the parameter(s) of the RRC configuration profiles may be RRC configured and may also be (de)activated or otherwise adapted via lower-layer signaling or based on certain events. The RRC configuration profiles may be configured for certain communication scenarios, use cases, for different purposes, and the like. For example, one or more RRC configuration profiles may be configured for the UE to support SCell operations, BWP-based operations, cell DTX/DRX operations, on-demand SSB transmission(s) from SCell(s), and the like. In some aspects, each of these features and/or procedures to update or reconfigure the RRC configuration profiles has its own, independent lower-layer or event-based (de)activation and/or (re)configuration mechanism. Some of these features and/or parameters may not support lower-layer and/or event-driven adaptation(s) (e.g., would require RRC reconfiguration). Thus, such wireless networks generally use independent or different mechanisms for updating or otherwise adapting the RRC configuration profiles and/or the parameters of the RRC configuration profiles, for UE.

As one example, in such wireless networks a UE can use a UE assistance information (UAI) messaging framework to communicate to the network relevant information at the UE side that includes overheating assistance information. The UE can indicate a reduced amount of component carriers (CCs)/multiple-input/multiple-output (MIMO) layers and/or an aggregated bandwidth if it is experiencing overheating. The UE can use the UAI framework to indicate in-device coexistence information. The UE can indicate if certain NR frequencies are affected by interference and/or if certain NR frequencies cause interference to other systems (e.g., Wi-Fi, GPS, etc.). The UE can use the UAI framework to indicate an adjustment to C-DRX parameters. For power saving purposes, the UE can suggest a preferred C-DRX configuration to the network.

In some aspects, an example of the timeline for the steps needed for the UE to report to the network using the UAI framework may be lengthy. First, the UE establishes an RRC connection and performs RRCReconfiguration procedures with the network. During the RRCReconfiguration, the network may provide a UAI configuration for each “event” or “information” (e.g., overheatingAssistanceConfig, idc-AssistanceConfig, drx-PreferenceConfig, etc.). If the UE is not configured for a certain “event” then it cannot report the associated UE information. Each configuration provides essentially one important parameter (e.g., ProhibitTimer) that allows the UE to report an “event”-related information only after each expiration of this timer. The network may adopt this approach to avoid too frequent reporting from the UE.

As one example during an overheating assistance information scenario, the UE may need to perform an access with the network, receive the RRC reconfiguration messaging, report information based on a certain timer (which may or may not be configured to 0 by the network), and then the network may provide a new configuration based on the information (hence, perform another RRC reconfiguration procedure). This approach may lead to increased latency of configuration and extra overhead.

A relevant problem associated with the such UE assistance information framework is that the UE needs to wait until after having established access to the network and receiving the RRC reconfiguration from the network before sending any UE assistance information. In such wireless networks, there is no framework to enable the UE to share such information early-on. This increases the latency for the reporting of information, which may be critical in some scenarios. In addition, the network may have configured reporting of certain information with a possibly “long” timer. As one example, a UE may be experiencing overheating before performing RACH and need to wait some time before reporting the overheating information and being configured accordingly. In another example, a UE may be experiencing interference and must wait before reporting critical information that can influence the UE’s access and/or performance. In addition, the UE assistant information is sent via RRC signaling through a dedicated RRC message that can increase overhead (e.g., each time the UE needs or wants to provide new information) and increase latency (e.g., RRC-layer message).

Accordingly, aspects of the described techniques provide for a unified and future-proof framework to (re)configure or otherwise adapt the RRC configuration profiles that have been configured for the UE 205. These techniques may be common or the same for RRC configuration profiles that are associated with different communication scenarios, use cases, and the like. The described techniques support a common framework for the dynamic adaptation (e.g., via lower-layer signaling and/or event triggered) of and across one or multiple RRC configuration profiles. In some cases, this may include support for one or multiple RRC configuration profile messages where each RRC configuration profile message may flexibly include (re)configuration of any combination or subset of parameters of the RRC configuration profiles configured for the UE 205.

As one example, at 215 the network entity 210 may transmit or otherwise output (and the UE 205 may receive or otherwise obtain) configuration information that includes a plurality of RRC configuration profiles for the UE 205. Each RRC configuration profile may include respective parameter information (e.g., a set of parameters) and may correspond to a respective communication scenario of one or more communication scenarios. Broadly, the parameter information of a respective RRC configuration profile may include any value, field, allocation, metric, or other information that is associated with or otherwise supports implementation of the respective RRC configuration profile.

As one example, the plurality of RRC configuration profiles may include N RRC configuration profiles, where N is a positive number of one or more. A first RRC configuration profile may include or be associated with a profile identifier (Profile ID_1) and have a set of parameters (e.g., parameter X_1, parameter Y_1, and parameter Z_1). Similarly, a second RRC configuration profile may include or be associated with a profile identifier (Profile ID_2) and have a set of parameters (e.g., parameter X_2, parameter Y_2, and parameter Z_2). This may continue for each RRC configuration profile until the N’th RRC communication profile, which may include or be associated with a profile identifier (Profile ID_N) and have a set of parameters (e.g., parameter X_N, parameter Y_N, and parameter Z_N). The techniques described herein provide for a common adaptation framework (e.g., a mechanism to update or switch) for one, some, or all of the RRC configuration profiles in the plurality of RRC configuration profiles. The common framework may be event-based and/or based on layer one/layer two (L1/L2)-based indications to (de)activate, switch, or otherwise update some of the RRC configuration profiles.

In some aspects, the common framework may provide flexibility to the network to create different RRC configuration profiles that are tailored for different purposes, use-cases, and examples, as well as providing an efficient way for dynamically adapting of the RRC configuration profiles. This may include defining and/or otherwise configuring an RRC configuration profile that is customized for network energy saving (NES) operations (e.g., a first communication scenario). In this example, the RRC configuration profile may include a lighter configuration or cancelation of some of the semi-static/periodic channels (such as any combination of physical downlink control channel (PDCCH) monitoring occasions, scheduling request (SR), sounding reference signal (SRS), channel state information-reference signal (CSI-RS), semi-persistent scheduling (SPS), configured grant-physical uplink shared channel (CG-PUSCH), synchronization signal block (SSB)/system information block (SIB)/random access channel (RACH) with a longer periodicity, or on-demand SSB/system information (SI)) for one or multiple cells. As one example, the NES operations may support SSB adaptation (e.g., narrowing down to define a new signaling to dynamically—not via RRC reconfiguration signaling—change the SSB periodicity).

This may include defining and/or otherwise configuring an RRC configuration profile for an SCell’s semi-active/(semi)dormant state (e.g., a second communication scenario) whose configuration (e.g., of parameters) is something in between an active state, deactivate state, and/or dormant state. This RRC configuration profile may be associated with the configurable and dynamic adaptation techniques described herein.

This may include defining and/or otherwise configuring an RRC configuration profile for accommodating a bursty traffic session with its associated quality-of-service (QoS) (e.g., a third communication scenario). The RRC configuration profile may be efficiently and swiftly activated and deactivated (e.g., such as when the traffic is served). This may include an RRC configuration profile being defined or otherwise configured to be specific to one feature or procedure (such as CSI-RS configuration, a measurement configuration, a SR configuration, a RACH configuration, etc., other communication scenarios) to allow more efficient adaptation.

Thus, the UE 205 may configure or be configured with different RRC configuration profiles (e.g., each profile can provide a different configuration of parameters to address, for example, overheating, interference, a UE’s C-DRX preferred configuration, or various other communication scenarios).

In some aspects, the described techniques may support the UE 205 suggesting or otherwise requesting an RRC configuration profile. This may include the UE 205 requesting the parameter(s) to be included in the RRC configuration profile and/or a list of one or multiple values and/or range of values for the associated parameters. The UE 205 may suggest a method and configuration for lower-layer adaptation or event-based adaptation of the RRC configuration profiles. The UE 205 may suggest (de)activation of an RRC configuration profile.

For example, at 220 the UE 205 may transmit or otherwise output (and the network entity 210 may receive or otherwise obtain) a requested RRC configuration profile. However, the requested RRC configuration profile may be different from each RRC configuration profile of the plurality of RRC configuration profiles. For example, the requested RRC configuration profile may be a completely different RRC configuration profile for a given communication scenario, may be a new RRC configuration profile (e.g., for a communication scenario that the UE has not been configured with), and/or may include updated value(s) and/or range(s) of values for parameter(s) of an RRC configuration profile. For example, the requested RRC configuration profile may include requested parameter information for a particular communication scenario. Accordingly, at 225 the UE 205 and the network entity 210 may perform wireless communication associated with the particular communication scenario. This may include the wireless communication being performed according to the requested RRC configuration profile when the network adopts the requested RRC configuration profile. This may include the wireless communication being performed according to the requested parameter information (e.g., using updated values or ranges of values) for an RRC configuration profile.

In some aspects, the UE 205 may transmit the requested RRC configuration profile during an initial access procedure (e.g., during a four-step RACH procedure or during a two-step RACH procedure) or during operations in a connected mode (e.g., in an RRC connected mode). When transmitted during the initial access procedure, the requested RRC configuration profile may be included in a RACH message three Msg3) in the four-step RACH procedure or in a RACH message A (MsgA) in the two-step RACH procedure. When transmitted while in the RRC connected mode, the requested RRC configuration profile may be included in RRC signaling, in a medium access control-control element (MAC-CE), or in a downlink control information (DCI) signaling.

Thus, during the initial access procedure or while operating in a connected mode, the UE 205 may send a simple indication (e.g., based on the UE’s status, some measurements, an expected traffic, or any other communication scenario) to the network (e.g., the network entity 210) to indicate the selected/suggested RRC configuration profile. This indication may be performed via lower layer signaling, which may reduce the latency and associated overhead of the configuration (e.g., being an indication only). In some cases, the indication or adaptation of the RRC configuration profiles may also be performed based on various triggering events. This approach may eliminate the need to perform RRC reconfiguration signaling, which increases the latency of configuration.

As a result of the received indication, the network may optionally apply the indicated/suggested RRC configuration profile and may or may not notify the UE 205 with acknowledgement/negative-acknowledgement (ACK/NACK) signaling. For example, the network entity 210 may transmit or otherwise output (and the UE 205 may receive or otherwise obtain) an ACK/NACK message that indicates the requested RRC configuration profile is usable to perform the wireless communication (e.g., the network has adopted the requested RRC configuration profile). In this case, the wireless communication performed between the UE 205 and the network entity 210 may be performed according to the requested RRC configuration profile. In this scenario, each respective parameter information (e.g., as included in the requested RRC configuration profile) may include respective indication of parameter values and/or indication(s) of requested parameter values. That is, the indication of the requested parameter values may include an indication of the actual parameter values and/or an indication of a range of parameter values.

In some aspects, the indication of the requested RRC configuration profile may or may not include an indication of a cause/reason or a list of causes/reasons associated with the requested RRC configuration profile. For example, the UE 205 may transmit or otherwise output (and the network entity 210 may receive or otherwise obtain) first information indicative of a reason for transmission of the requested RRC configuration profile. In some aspects, the reason for the transmission may correspond to a communication scenario (e.g., a scenario, condition, event, etc., detected or otherwise identified by the UE 205). As discussed above, the techniques described herein provide for any variety of communication scenarios, such as an overheating scenario of the UE 205, an expected traffic pattern scenario (e.g., increased/decreased uplink traffic pattern or downlink traffic pattern) of the UE 205, an interference scenario (e.g., excessive actual or expected interference at the UE 205), a mobility scenario of the UE 205, a C-DRX scenario, and/or based on a capability of the UE 205.

Transmitting the first information and the requested RRC configuration profile may include the UE 205 transmitting second information that identifies or otherwise indicates both the first information (e.g., the reason) as well as the requested RRC configuration profile. As discussed above, the second information may be transmitted during an initial access procedure (e.g., in RACH Msg3 or RACH MsgA) or during operations in a connected mode (e.g., in RRC signaling). In this aspect, the wireless communication performed between the UE 205 and the network entity 210 may be based on the second information (e.g., the network may adopt the requested RRC configuration profile in view of the reason for the requested change).

In some cases, the UE 205 may indicate that it supports this feature (e.g., transmitting the requested RRC configuration profile) to the network through its capability signaling. For example, the UE 205 may transmit or otherwise output (and the network entity 210 may receive or otherwise obtain) capability information that indicates that the UE 205 supports a capability to request one or more requested RRC configuration profiles. Additionally, the UE 205 may indicate how many and/or what type of requested RRC configuration profiles it can provide, and/or for which causes are reasons it can suggest the requested RRC configuration profile(s).

In some cases, the network may or may not authorize the UE 205 to use this feature (e.g., to indicate a requested RRC configuration profile). For example, the network entity 210 may transmit or otherwise output (and the UE 205 may receive or otherwise obtain) one or more messages that indicate whether transmissions from the UE 205 indicating requested RRC configuration profile(s) are enabled or activated or are disabled or deactivated. The UE 205 may refrain from transmitting indication of requested RRC configuration profile(s) to the network entity 210 when this features is disabled or deactivated.

Other than the situation where the UE 205 can autonomously configure RRC configuration profiles or be configured with RRC configuration profiles, the network may ask the UE 205 to provide suggestion(s) for a type of RRC configuration profile and/or for a cause or reason. In some cases, the network may limit the UE’s suggestions to a maximum number of RRC configuration profiles (e.g., in total or within a configured time) and/or a type of RRC configuration profiles or associated causes.

In some cases, the network may deauthorize a certain UE to use this feature. This may be dynamic (e.g., the network may authorize the UE for a certain amount of time, or for a given tracking area/location, or for certain cell(s)/frequencies/etc.). In some cases, the UE 205 may request to send an RRC configuration profile suggestion (e.g., for a given type, cause, etc.).

Accordingly, instead of having only the network that can configure specific RRC configuration profiles and communicate those configurations with the UEs, the described techniques support allowing the UE 205 the possibility of configuring different RRC configuration profiles based on, as an example, UE status, capabilities, mobility, or any other communication scenarios. The UE 205 may be able to configure dedicated/tailored RRC configuration profiles that can better address its needs. This may be based on support for the UE 205 to configure (or suggest) one or more RRC configuration profiles which can be based on any variety of communication scenarios. As one example of a communication scenario, the UE 205 may create RRC configuration profiles based on its needs (e.g., based on its expected traffic and/or UE capabilities) via the transmission of the indication of the requested RRC configuration profile. As another example of a communication scenario, the UE 205 may configure RRC configuration profile(s) to specifically address certain states it can encounter such as overheating, mobility, etc. As another example of a communication scenario, the UE 205 may create RRC configuration profile(s) for the purpose of energy savings (e.g., an energy-saving profile can configure longer C-DRX cycle parameters). The UE 205 may configure RRC configuration profile(s) for different C-DRX configurations or scenarios. If the UE 205 expects incoming traffic, the UE 205 may configure shorter sleep times or, vice versa, longer sleep times if no traffic is expected.

In some aspects, when configuring an RRC configuration profile (e.g., the requested RRC configuration profile), the UE 205 may decide to include any parameters or the structure of the RRC configuration profile(s) (e.g., the parameters to provide or set), which may be (pre)defined or provided by the network (e.g., the parameters to set for “overheating” may be (pre)defined or provided by the network).

In some cases, each RRC configuration profile may have an associated/configured N-bit profile identifier (ID) to be used as a reference for future indication(s). Additionally, or alternatively, there may be a list of profiles/profile IDs available/accessible by the network. The UE 205 can receive the list and then may suggest a subset of profiles to be configured/used by this UE 205 (e.g., signal the identifier in the transmission of the requested RRC configuration profile). For example, the UE 205 may transmit or otherwise output (and the network entity 210 may receive or otherwise obtain) first information that includes an identifier of a particular RRC configuration profile of the plurality of RRC configuration profiles The requested RRC configuration profile may include an indication (e.g., using one or more bits, values, fields, etc.) to replace the particular RRC configuration profile with the requested RRC configuration profile according to the identifier. To transmit the first information and the requested RRC configuration profile, the UE 205 may transmit second information that includes both the requested RRC configuration profile as well as the first information. As discussed above, the UE 205 may transmit the second information during an initial access procedure (e.g., in a RACH Msg3 or in a RACH MsgA) or while operating in an RRC connected mode (e.g., in RRC signaling or other signaling). Again, the UE 205 and the network entity 210 may perform the wireless communication according to the second information.

Accordingly, the described techniques provide for how the UE 205 can communicate to the network the different RRC profiles (e.g., the requested RRC configuration profile). Moreover, if the UE 205 provided the indication of the requested RRC configuration profiles at an earlier time, the described techniques provide techniques for how the UE 205 can update those profiles. Accordingly, in some aspects the described techniques may support techniques for the UE 205 to communicate and/or update one or more UE RRC configuration profiles to the network. As discussed, the UE 205 may communicate and/or update the different RRC configuration profiles to the network during the initial access procedure and/or during connected mode operations. In some cases, the UE 205 may use dedicated RRC signaling to communicate the requested RRC configuration profile(s) to the network. Additionally, or alternatively, the UE 205 may push the UE’s requested RRC configuration profile(s) to an over-the-top (OTT) server where the network may pull or otherwise retrieve each requested RRC configuration profile from the server. In some cases, this push/pull operations may be done proactively so the UE 205 may adopt certain profile(s) when performing, for example, a RACH procedure.

In some cases, different requested RRC configuration profile(s) can be (pre)defined and/or UE-type specific (for example, customer premise equipment (CPE)-specific RRC profiles) or based on UE capabilities. In the case of an update, the UE 205 may include an identifier for the existing RRC configuration profile(s) to update. In some cases, the update may indicate a request or suggestion to replace a certain RRC configuration profile (e.g., to replace a particular RRC configuration profile of the plurality of RRC configuration profiles with the requested RRC configuration profile). In some cases, the requested update to the RRC configuration profile may provide and/or suggest a delta update (e.g., an amount of change to one or more values, parameters, ranges of values or parameters, etc.) as compared to an existing RRC configuration profile. Signaling the delay update may reduce the signaling overhead.

Aspects of the described techniques provide for how the network may reply to the indication of the preferred/suggested profile(s) by the UE (e.g., the requested RRC configuration profile). This may be based on support for the network to provide feedback (e.g., ACK/NACK feedback) associated with the UE’s preferred/suggested profile indication (e.g., the requested RRC configuration profile). The network may send a response confirming one or multiple RRC configuration profile(s) has or have been configured (e.g., an ACK indication). If the UE 205 indication of the requested RRC configuration profile was sent during a RACH procedure, the network may provide feedback in a RACH random access response (RAR)/RACH message two (Msg2) message (e.g., if dedicated preambles were assigned for the RRC configuration profile(s)) or in a RACH message four (Msg4) if the UE 205 provided the indication in the RACH Msg3. If the indication was provided during connected mode operations, the network may provide feedback through dedicated RRC signaling, DCI signaling, wakeup signal (WUS) signaling, low power-WUS (LP-WUS) signaling, or any other signaling means. If the network cannot accommodate a certain profile (e.g., NACK feedback), the network entity 210 may or may not provide an updated/modified RRC configuration profile.

In some cases, the network may also suggest an updated RRC configuration profile any time through dedicated RRC signaling or via a common DCI format. Additionally, or alternatively, the network may indicate to the UE 205 to fall back to a legacy/default RRC configuration profile and provide the indication of the legacy/default RRC configuration profile and/or an identifier for that profile (e.g., in the case the fallback profile(s) was previously configured/communicated by either the UE 205 or the network entity 210).

In some cases, in the UE’s indication for the preferred/suggested profile (e.g., the requested RRC configuration profile), the UE 205 may also indicate the fallback profile(s) (e.g., an identifier for the profile(s) and/or the actual RRC profile(s) to be used for fallback) that the network may follow. In some cases, the UE 205 may provide the indication for the profile to use when communicating one or more profile(s) to the network (e.g., wireless communication and indication of the requested RRC configuration profile can be within the same message).

As discussed above, the RRC configuration profile(s) may provide a configuration with a specific value for each parameter. However, the RRC configuration profiles may be configured to provide one or multiple values or a range of values for the associated parameters. This may be based on support for RRC configuration profiles where one or multiple values or a range of such values for the associated parameters can be configured. In an RRC configuration profile, all or a subset of parameters may be configured with multiple values or a range of values. In the case where the RRC configuration profile (e.g., with multiple or a range of values for all or certain parameters) is provided by the network, the UE 205 may autonomously choose a value from multiple values or a range of values (e.g., without necessarily further notifying the network). Additionally, or alternatively, the UE 205 may choose a value and suggest it to the network. In the case where the requested RRC configuration profile is provided/suggested by the UE, the network may pick a value from the multiple values or range of values provided and adopt the requested changes/reconfigurations. The network may reply to the UE 205 with a specific value configuration of those parameters (e.g., via RRC reconfiguration signaling, in some examples).

In some cases, the UE 205 may configure a cause or list of causes pertaining to a certain RRC configuration profile. This may be based on support for the UE 205 to configure and/or indicate a cause or reason (or list of causes or reasons) to be associated with the RRC configuration profile (e.g., a cause may be related but not limited to overheating, interference, or any other communication scenario). In some cases, a cause or list of causes may be part of the RRC configuration profile. An RRC configuration profile may be configured with a cause or a list of associated causes, although some RRC configuration profiles may share the same cause(s). The cause may be used for (de)activation of certain RRC configuration profile(s) (e.g., the UE 205 may report overheating and the network would understand the corresponding RRC configuration profile(s) may be associated with the reported cause). In some aspects, the network may indicate back to the UE 205 the (de)activated RRC configuration profile(s) (e.g., using an associated profile identifier). Additionally, or alternatively, when a RRC configuration profile is to be (de)activated with an indication of the associated profile identifier, such an indication may further include one or more associated cause(s). This aspect may be applicable to both the network-indicated and the UE-indicated adaptation). In some cases, the UE 205 may assign a cause or list of causes to a RRC configuration profile (e.g., interference, overheating, etc.) based on its own capabilities, mobility, current status, traffic, or any other communication scenario.

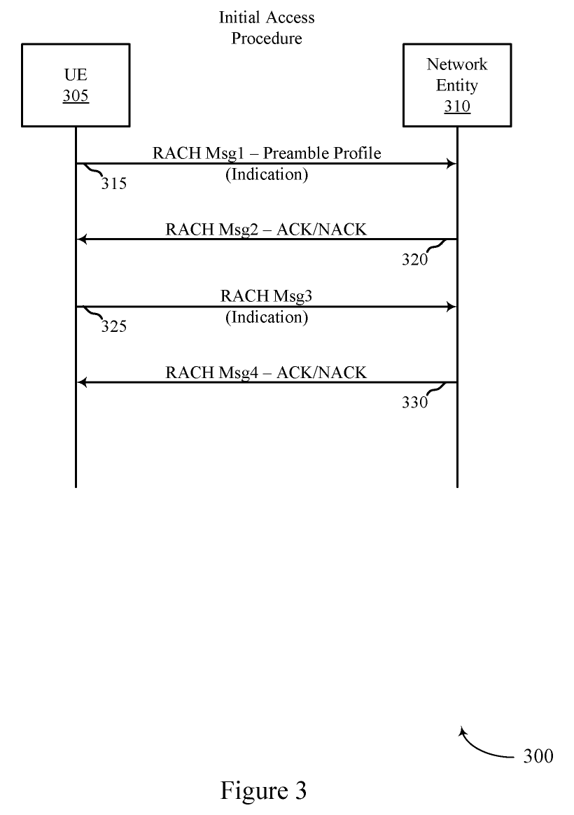

FIG. 3 shows an example of a diagram 300 that supports AI-native RRC profile adaptation for UE. Aspects of the diagram 300 may be implemented or and/or implemented by aspects of the wireless communication system 100 and/or aspects of the signaling diagram 200. Aspects of the diagram 300 may be implemented at and/or implemented by a UE 305 and a network entity 310, which may be examples of the corresponding devices described herein. In some cases, the UE 305 may also be referred to as a network entity.

As discussed above, the described techniques provide for a network entity to transmit or otherwise output (and the UE to receive or otherwise obtain) configuration information that includes a plurality of RRC configuration profiles for the UE. Each RRC configuration profile may include respective parameter information (e.g., a set of parameters) and may correspond to a respective communication scenario of one or more communication scenarios. Broadly, the parameter information of a respective RRC configuration profile may include any value, field, allocation, metric, or other information that is associated with or otherwise supports implementation of the respective RRC configuration profile.

The techniques described herein provide for a common adaptation framework (e.g., a mechanism to update or switch) for one, some, or all of the RRC configuration profiles in the plurality of RRC configuration profiles. The common framework may be event-based and/or based on layer one/layer two (L1/L2)-based indications to (de)activate, switch, or otherwise update some of the RRC configuration profiles.

In some aspects, the common framework may provide flexibility to the network to create different RRC configuration profiles that are tailored for different purposes, use-cases, and/or any other communication scenarios, as well as providing an efficient way for dynamically adapting of the RRC configuration profiles. This may include defining and/or otherwise configuring an RRC configuration profile that is customized for various communication scenarios.

Thus, the UE may configure or be configured with different RRC configuration profiles (e.g., each profile can provide a different configuration of parameters to address, for example, overheating, interference, a UE’s C-DRX preferred configuration, or various other communication scenarios). The described techniques may support the UE suggesting or otherwise requesting an RRC configuration profile. This may include the UE requesting the parameter(s) to be included in the RRC configuration profile and/or a list of one or multiple values and/or range of values for the associated parameters. The UE may suggest a configuration for lower-layer adaptation or event-based adaptation of the RRC configuration profiles. The UE may suggest (de)activation of an RRC configuration profile.

For example, the UE may transmit or otherwise output (and the network entity may receive or otherwise obtain) a requested RRC configuration profile. However, the requested RRC configuration profile may be different from each RRC configuration profile of the plurality of RRC configuration profiles. For example, the requested RRC configuration profile may be a completely different RRC configuration profile for a given communication scenario, may be a new RRC configuration profile (e.g., for a communication scenario that the UE has not been configured with), and/or may include updated value(s) and/or range(s) of values for parameter(s) of an RRC configuration profile. For example, the requested RRC configuration profile may include requested parameter information for a particular communication scenario. Accordingly, the UE and the network entity may perform wireless communication associated with the particular communication scenario. This may include the wireless communication being performed according to the requested RRC configuration profile when the network adopts the requested RRC configuration profile. This may include the wireless communication being performed according to the requested parameter information (e.g., using updated values or ranges of values) for an RRC configuration profile.

As also discussed above, the UE may transmit the request for the requested RRC configuration profile while operating in a connected mode and/or during an initial access procedure. The diagram 300 illustrates an example where the transmission of the indication of the requested RRC configuration profile is performed during the initial access procedure (e.g., a RACH procedure). The example shown in FIG. 3 illustrates an example of a four-step RACH procedure but it is to be understood that the described techniques may be equally applicable during a two-step RACH procedure (e.g., using RACH MsgA).

At 315, the UE 305 may transmit or otherwise output (and the network entity 310 may receive or otherwise obtain) a RACH message one (Msg1). The RACH Msg1 may be a RACH preamble (e.g., sequence) that the UE 305 transmits to initiate the RACH procedure with the network entity 310. In some cases, the UE 305 may transmit the indication of the requested RRC configuration profile in the RACH Msg1.

At 320, the network entity 310 may transmit or otherwise output (and the UE 305 may receive or otherwise obtain) a RACH Msg2. The RACH Msg2 may also be referred to as a RAR message within the four-step RACH procedure. In some examples, the network entity 310 may transmit ACK/NACK information for the indication of the requested RRC configuration profile (e.g., when included in the RACH Msg1).

Additionally, or alternatively, the indication of the requested RRC configuration profile may be provided in the RACH Msg3. For example, at 325 the UE 305 may transmit or otherwise output (and the network entity 310 may receive or otherwise obtain) the RACH Msg3. In some examples, the RACH Msg3 may be used to carry or otherwise convey the indication of the requested RRC configuration profile from the UE.

At 330, the network entity 310 may transmit or otherwise output (and the UE 305 may receive or otherwise obtain) a RACH Msg4. In some cases, the RACH Msg4 may be used by the network entity 310 to carry or otherwise convey ACK/NACK feedback associated with the requested RRC configuration profile (e.g., as provided in either or both of the RACH Msg1 or the RACH Msg3).

Accordingly, the diagram 300 illustrates an example of how the UE provides an indication of the preferred/suggested profile (e.g., the requested RRC configuration profile) to the network (e.g., the network entity 310). This may be based on support for the UE 305 to indicate (e.g., suggest or otherwise request) RRC configuration profile(s) during both the initial access procedure and when operating in the connected mode. In some cases, the indication may contain the identifier(s) of the preferred/suggested profile(s) (e.g., identifier(s) of the requested RRC configuration profile(s)). A RRC configuration profile indication for the UE 305 performing the initial access procedure can be triggered by any condition, such as but not limited to prior measurements on certain cells/frequencies, a current UE status, an expected traffic, or any other communication scenario that the UE 305 may encounter. If the UE 305 is performing the initial access procedure, it may indicate the requested RRC configuration profile(s)

during the RACH procedure (e.g., in the RACH Msg3) so the network can assign the requested/suggested RRC configuration profile(s). Or the network may allocate dedicated preambles/SRs/SRSs, etc. for certain RRC configuration profile(s), if the network had already some knowledge of the UE’s profile(s). In some aspects, dedicated resources may be UE-specific or UE-type specific (e.g., for CPE devices, etc.). The UE-type dedicated resources may be provided via SIB and/or sidelink signaling. The UE-specific dedicated resources may be provided through dedicated RRC signaling.

In the case of a two-step RACH procedure, the requested RRC configuration profile(s) indication may be indicated via either the RACH MsgA-preamble and/or the RACH MsgA-payload. In some cases, the network may or may not provide the ACK/NACK feedback for the indicated RRC configuration profile(s) (e.g., in the RACH Msg2 and/or the RACH Msg4). Through indication of the desired RRC configuration profile(s) during the RACH procedure, the UE may provide an early-on indication of its preferred/suggested RRC configuration profile(s). This can lead to reduced overhead (e.g., no need to provide UAI signaling), reduced latency for the configuration of certain parameters (e.g., no need to wait until exchanging UAI signal after the RACH procedure), and/or reduced energy consumption for both the network and the UE 305.

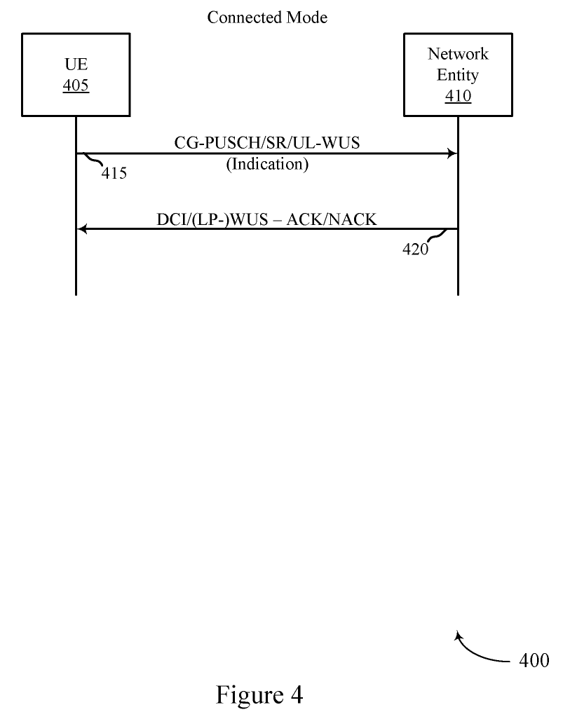

FIG. 4 shows an example of a diagram 400 that supports AI-native RRC profile adaptation for UE. Aspects of the diagram 400 may be implemented or and/or implemented by aspects of the wireless communication system 100 and/or aspects of the signaling diagram 200. Aspects of the diagram 400 may be implemented at and/or implemented by a UE 405 and a network entity 410, which may be examples of the corresponding devices described herein. In some cases, the UE 405 may also be referred to as a network entity.

As discussed above, the described techniques provide for a network entity to transmit or otherwise output (and the UE to receive or otherwise obtain) configuration information that includes a plurality of RRC configuration profiles for the UE. Each RRC configuration profile may include respective parameter information (e.g., a set of parameters) and may correspond to a respective communication scenario of one or more communication scenarios. Broadly, the parameter information of a respective RRC configuration profile may include any value, field, allocation, metric, or other information that is associated with or otherwise supports implementation of the respective RRC configuration profile.

The techniques described herein provide for a common adaptation framework (e.g., a mechanism to update or switch) for one, some, or all of the RRC configuration profiles in the plurality of RRC configuration profiles. The common framework may be event-based and/or based on L1/L2-based indications to (de)activate, switch, or otherwise update some of the RRC configuration profiles.

In some aspects, the common framework may provide flexibility to the network to create different RRC configuration profiles that are tailored for different purposes, use-cases, and/or any other communication scenarios, as well as providing an efficient way for dynamically adapting of the RRC configuration profiles. This may include defining and/or otherwise configuring an RRC configuration profile that is customized for various communication scenarios.

Thus, the UE may configure or be configured with different RRC configuration profiles (e.g., each profile can provide a different configuration of parameters to address, for example, overheating, interference, a UE’s C-DRX preferred configuration, or various other communication scenarios). The described techniques may support the UE suggesting or otherwise requesting an RRC configuration profile. This may include the UE requesting the parameter(s) to be included in the RRC configuration profile and/or a list of one or multiple values and/or range of values for the associated parameters. The UE may suggest a configuration for lower-layer adaptation or event-based adaptation of the RRC configuration profiles. The UE may suggest (de)activation of an RRC configuration profile.

For example, the UE may transmit or otherwise output (and the network entity may receive or otherwise obtain) a requested RRC configuration profile. However, the requested RRC configuration profile may be different from each RRC configuration profile of the plurality of RRC configuration profiles. For example, the requested RRC configuration profile may be a completely different RRC configuration profile for a given communication scenario, may be a new RRC configuration profile (e.g., for a communication scenario that the UE has not been configured with), and/or may include updated value(s) and/or range(s) of values for parameter(s) of an RRC configuration profile. For example, the requested RRC configuration profile may include requested parameter information for a particular communication scenario. Accordingly, the UE and the network entity may perform wireless communication associated with the particular communication scenario. This may include the wireless communication being performed according to the requested RRC configuration profile when the network adopts the requested RRC configuration profile. This may include the wireless communication being performed according to the requested parameter information (e.g., using updated values or ranges of values) for an RRC configuration profile.

As also discussed above, the UE may transmit the request for the requested RRC configuration profile while operating in a connected mode and/or during an initial access procedure. The diagram 400 illustrates an example where the transmission of the indication of the requested RRC configuration profile is performed while operating in a connected mode. For example, the UE 405 may have previously performed a RACH procedure with the network entity 410 and have an active connection established. Accordingly, at 415 the UE 405 may transmit or otherwise output (and the network entity 410 may receive or otherwise obtain) an indication of a requested RRC configuration profile. The requested RRC configuration profile may be different from the RRC configuration profiles in the plurality of RRC configuration profiles. The UE 405 may transmit the indication of the requested RRC configuration profile via various uplink signaling, such as in a CG-PUSCH message, in a SR, in an uplink-WUS (UL-WUS), or any other uplink signaling.

At 420, the network entity 410 may transmit or otherwise output (and the UE 405 may receive or otherwise obtain) a downlink message. In some cases, the downlink message may carry or otherwise convey ACK/NACK feedback associated with the requested RRC configuration profile. The downlink message may be transmitted in any downlink signaling, such as in a DCI message, using WUS, using LP-WUS, or any other downlink signal.

Accordingly, the diagram 400 illustrates an example where the indication of the requested RRC configuration profile is received from the UE 405 while operating in the connected mode. In some aspects, the indication may be triggered by any condition, such as a change in the UE status (e.g., overheating, sudden mobility), based on some measurements of metrics from the UE (e.g., for interference), or a sudden change in the traffic for the UE 405. If the UE 405 is operating in the connected mode, the UE 405 may indicate its preferred/suggested RRC configuration profile(s) according to using some already configured resources (e.g., CG-PUSCH/PUCCH/SR/SRS), a few bits in the UL-WUS/LP-UL-WUS can be used to indicate the requested RRC configuration profile(s), or via other means. In some cases, there may be a mapping from one or more RRC configuration profile(s) identifiers to one/more resources. Accordingly, in some aspects the UE 405 may transmit the indication of the requested RRC configuration profile using one or more resources and/or one or more parameters. In this aspects, the one or more resources and/or the one or more parameters may identify the requested RRC configuration profile.

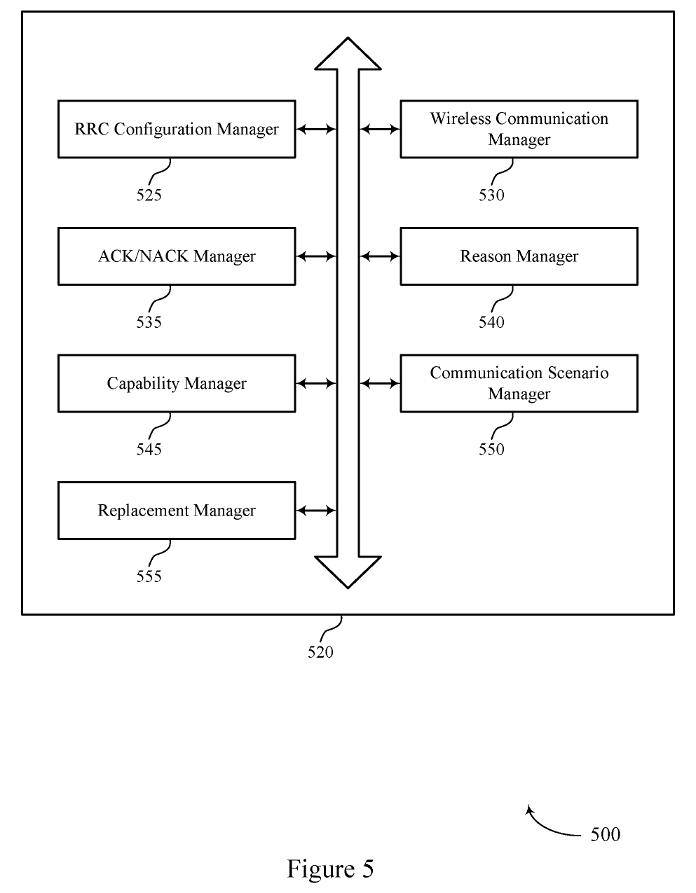

FIG. 5 shows an example 500 of a processing system 520 that supports AI-native RRC profile adaptation for UE. A processing system 520 may be an example of a processing system 140 (such as of a UE 115) and may include an RRC configuration manager 525, a wireless communication manager 530, an ACK/NACK manager 535, a reason manager 540, a capability manager 545, a communication scenario manager 550, a replacement manager 555, or any combination thereof. A processing system 520, or various component thereof, may be an example of means for performing (such as a means for causing a UE 115 to perform) various techniques described herein.

The RRC configuration manager 525 may be configured to cause the UE 115 to receive configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios. In some examples, the RRC configuration manager 525 may be configured to cause the UE 115 to transmit a requested RRC configuration profile that is different from each RRC configuration profile of the set of multiple RRC configuration profiles, where the requested RRC configuration profile includes requested parameter information for a particular communication scenario of the one or more communication scenarios. The wireless communication manager 530 may be configured to cause the UE 115 to perform wireless communication associated with the particular communication scenario.

In some examples, to support transmitting the requested RRC configuration profile, the RRC configuration manager 525 may be configured to cause the UE 115 to transmit the requested RRC configuration profile during an initial access procedure of the network entity or during operation of the network entity in a connected mode.

In some examples, the requested RRC configuration profile is included in a RACH Msg3, a RACH MsgA, or an RRC signal. In some examples, the ACK/NACK manager 535 may be configured to cause the UE 115 to receive an ACK/NACK message that indicates the requested RRC configuration profile is usable to perform the wireless communication. In some examples, to support to perform the wireless communication, the ACK/NACK manager 535 may be configured to cause the UE 115 to perform, based on the requested RRC configuration profile, the wireless communication. In some examples, each respective parameter information includes one or more respective indications of parameter values. In some examples, the requested parameter information includes one or more indications of requested parameter values. In some examples, the one or more indications of requested parameter values include one or more indications of a range of parameter values. In some examples, the requested parameter information includes one or more indications of a range of parameter values.

In some examples, the reason manager 540 may be configured to cause the UE 115 to transmit first information indicative of a reason for transmission of the requested RRC configuration profile. In some examples, the reason for the transmission of the requested RRC configuration corresponds to a communication scenario that comprises at least one of: an overheating scenario, an expected traffic pattern scenario of the network entity, a capability of the network entity, an interfering scenario, a mobility scenario at the network entity, a C-DRX scenario, or a capability of the network entity. In some examples, to support transmitting the requested RRC configuration profile and transmitting the first information, the reason manager 540 may be configured to cause the UE 115 to transmit second information, and where the second information includes the requested RRC configuration profile and the first information.

In some examples, to support transmitting the second information, the reason manager 540 may be configured to cause the UE 115 to transmit the second information during an initial access procedure of the network entity or during operation of the network entity in a connected mode. In some examples, the second information is included in a RACH Msg3, a RACH MsgA, or an RRC signal. In some examples, to support performing the wireless communication, the reason manager 540 may be configured to cause the UE 115 to perform, based on the second information, the wireless communication.

In some examples, the capability manager 545 may be configured to cause the UE 115 to transmit capability information that indicates that the network entity supports a capability to request one or more requested RRC configuration profiles. In some examples, the one or more communication scenarios include at least one of: an overheating scenario, an expected traffic pattern scenario of the network entity, an interference scenario, a mobility scenario at the network entity, a C-DRX scenario, or a capability of the network entity.

In some examples, the replacement manager 555 may be configured to cause the UE 115 to transmit first information, where the first information includes an identifier of a particular RRC configuration profile of the set of multiple RRC configuration profiles, and an indication to replace the particular RRC configuration profile with the requested RRC configuration profile. In some examples, to support transmitting the requested RRC configuration profile and transmitting the first information, the replacement manager 555 may be configured to cause the UE 115 to transmit second information, and where the second information includes the requested RRC configuration profile and the first information.

In some examples, to support transmitting the second information, the replacement manager 555 may be configured to cause the UE 115 to transmit the second information during an initial access procedure of the network entity or during operation of the network entity in a connected mode. In some examples, the second information is included in a RACH Msg3, a RACH MsgA, or an RRC signal. In some examples, to support performing the wireless communication, the replacement manager 555 may be configured to cause the UE 115 to perform, based on the second information, the wireless communication.

In some examples, to support transmitting the requested RRC configuration profile, the RRC configuration manager 525 may be configured to cause the UE 115 to transmit an indication of the requested RRC configuration profile using one or more resources, or one or more parameters, and where the one or more resources, or the one or more parameters used to transmit the indication identify the requested RRC configuration profile.

In some examples, to support performing the wireless communication, the wireless communication manager 530 may be configured to cause the UE 115 to perform the wireless communication based on one or more metrics that satisfy a threshold condition. In some examples, the one or more metrics correspond to a communication scenario that comprises at least one of: an overheating scenario, an expected traffic pattern scenario, an interference scenario, a mobility scenario, a C-DRX scenario, or a capability. In some examples, to support performing the wireless communication, the wireless communication manager 530 may be configured to cause the UE 115 to perform the wireless communication using the requested RRC configuration profile.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for a UE to, based on an AI that is native to the UE, request updates to one or more of the configured RRC configuration profiles while operating in an RRC connected mode and/or during an initial access procedure. The dynamic updates to the RRC configuration profiles may provide a uniform technique that enables the UE and the network to update any type of RRC configuration profiles (e.g., correspond to different communication scenarios).

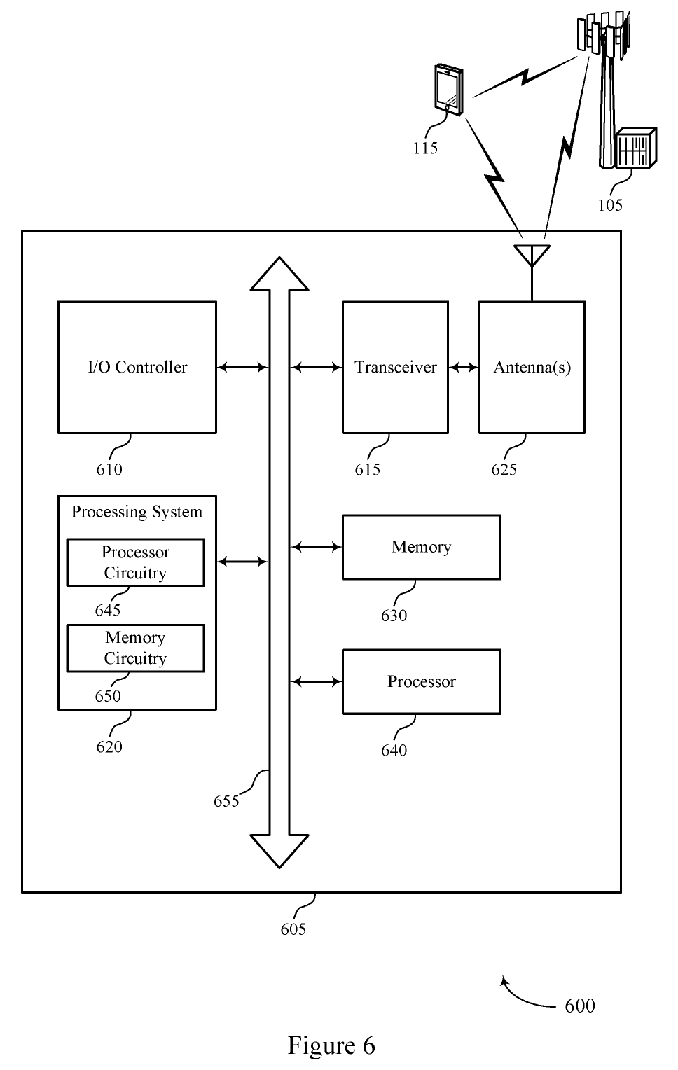

FIG. 6 shows an example of a system 600 including a device 605 that supports AI-native RRC profile adaptation for UE. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support AI-native RRC profile adaptation for UE. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for a UE to, based on an AI that is native to the UE, request updates to one or more of the configured RRC configuration profiles while operating in an RRC connected mode and/or during an initial access procedure. The dynamic updates to the RRC configuration profiles may provide a uniform technique that enables the UE and the network to update any type of RRC configuration profiles (e.g., correspond to different communication scenarios).

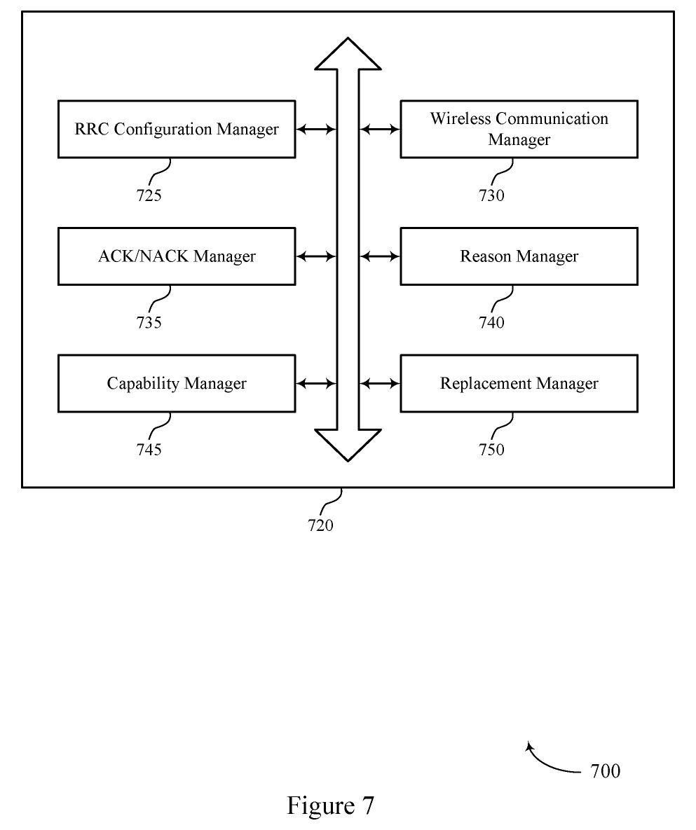

FIG. 7 shows an example 700 of a processing system 720 that supports AI-native RRC profile adaptation for UE. A processing system 720 may be an example of a processing system 145 (such as network entity 105) and may include an RRC configuration manager 725, a wireless communication manager 730, an ACK/NACK manager 735, a reason manager 740, a capability manager 745, a replacement manager 750, or any combination thereof. A processing system 720, or various component thereof, may be an example of means for performing (such as a means for causing a network entity 105 to perform) various techniques described herein.

The RRC configuration manager 725 may be configured to cause the network entity 105 to transmit configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios. In some examples, the RRC configuration manager 725 may be configured to cause the network entity 105 to receive a requested RRC configuration profile that is different from each RRC configuration profile of the set of multiple RRC configuration profiles, where the requested RRC configuration profile includes requested parameter information for a particular communication scenario of the one or more communication scenarios. The wireless communication manager 730 may be configured to cause the network entity 105 to perform wireless communication associated with the particular communication scenario.

In some examples, to support receiving the requested RRC configuration profile, the RRC configuration manager 725 may be configured to cause the network entity 105 to receive the requested RRC configuration profile during an initial access procedure associated with the network entity or during operations associated with a connected mode. In some examples, the requested RRC configuration profile is included in a RACH Msg3, a RACH MsgA, or an RRC signal.

In some examples, the ACK/NACK manager 735 may be configured to cause the network entity 105 to transmit an ACK/NACK message that indicates the requested RRC configuration profile is usable to perform the wireless communication. In some examples, to support performing the wireless communication, the ACK/NACK manager 735 may be configured to cause the network entity 105 to perform, based on the requested RRC configuration profile, the wireless communication. In some examples, each respective parameter information includes one or more respective indications of parameter values. In some examples, the requested parameter information includes one or more indications of requested parameter values. In some examples, the one or more indications of requested parameter values include one or more indications of a range of parameter values. In some examples, the requested parameter information includes one or more indications of a range of parameter values.

In some examples, the reason manager 740 may be configured to cause the network entity 105 to receive first information indicative of a reason for transmission of the requested RRC configuration profile. In some examples, the reason for the transmission of the requested RRC configuration profile corresponds to a communication scenario that includes at least one of: an overheating scenario, an expected traffic pattern scenario, an interfering scenario, a mobility scenario, a C-DRX scenario, or a capability. In some examples, to support receiving the requested RRC configuration profile and receiving the first information, the reason manager 740 may be configured to cause the network entity 105 to receive second information, where the second information includes the requested RRC configuration profile and the first information.

In some examples, to support receiving the second information, the reason manager 740 may be configured to cause the network entity 105 to receive the second information during an initial access procedure of the network entity or during operation associated with a connected mode. In some examples, the second information is included in a RACH Msg3, a RACH MsgA, or an RRC signal. In some examples, to support performing the wireless communication, the reason manager 740 may be configured to cause the network entity 105 to perform, based on the second information, the wireless communication.

In some examples, the capability manager 745 may be configured to cause the network entity 105 to receive capability information that indicates support for a capability to request one or more requested RRC configuration profiles. In some examples, the one or more communication scenarios include at least one of: an overheating scenario, an expected traffic pattern scenario, an interference scenario, a mobility scenario, a C-DRX scenario, or a capability.

In some examples, the replacement manager 750 may be configured to cause the network entity 105 to receive first information, where the first information includes an identifier of a particular RRC configuration profile of the set of multiple RRC configuration profiles, and an indication to replace the particular RRC configuration profile with the requested RRC configuration profile. In some examples, to support receiving the requested RRC configuration profile and receiving the first information, the replacement manager 750 may be configured to cause the network entity 105 to receive second information, where the second information includes the requested RRC configuration profile and the first information.

In some examples, to support receiving the second information, the replacement manager 750 may be configured to cause the network entity 105 to receive the second information during an initial access procedure of the network entity or during operation in a connected mode. In some examples, the second information is included in a RACH Msg3, a RACH MsgA, or an RRC signal. In some examples, to support performing the wireless communication, the replacement manager 750 may be configured to cause the network entity 105 to perform, based on the second information, the wireless communication.

In some examples, to support receiving the requested RRC configuration profile, the RRC configuration manager 725 may be configured to cause the network entity 105 to receive an indication of the requested RRC configuration profile using one or more resources, or one or more parameters, where the one or more resources, or the one or more parameters used to receive the indication identify the requested RRC configuration profile.

In some examples, to support performing the wireless communication, the wireless communication manager 730 may be configured to cause the network entity 105 to perform the wireless communication based on one or more metrics that satisfy a threshold condition. In some examples, the one or more metrics correspond to a communication scenario that comprises at least one of: an overheating scenario, an expected traffic pattern scenario, an interference scenario, a mobility scenario, a C-DRX scenario, or a capability. In some examples, to support performing the wireless communication, the wireless communication manager 730 may be configured to cause the network entity 105 to perform the wireless communication using the requested RRC configuration profile.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for a UE to, based on an AI that is native to the UE, request updates to one or more of the configured RRC configuration profiles while operating in an RRC connected mode and/or during an initial access procedure. The dynamic updates to the RRC configuration profiles may provide a uniform technique that enables the UE and the network to update any type of RRC configuration profiles (e.g., corresponding to different communication scenarios).

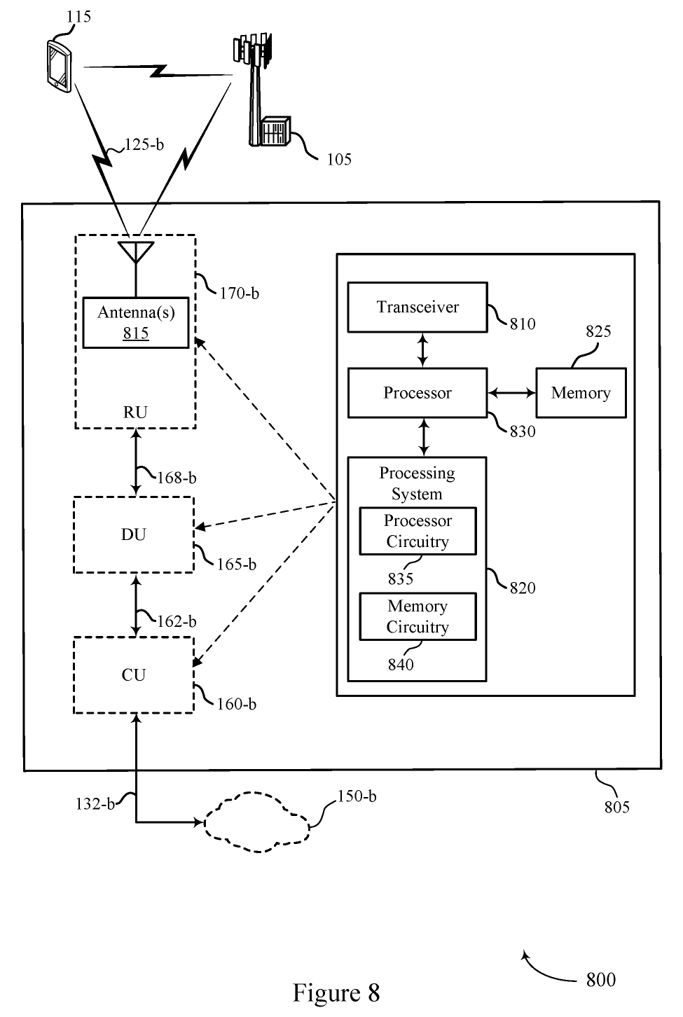

FIG. 8 shows an example of a system 800 including a device 805 that supports AI-native RRC profile adaptation for UE. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 720. For example, the processing system 820 may include processor circuitry 835 and memory circuitry 840 that stores code, and the processing system 820 may be configured to cause the device 805 to perform operations that support AI-native RRC profile adaptation for UE. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for a UE to, based on an AI that is native to the UE, request updates to one or more of the configured RRC configuration profiles while operating in an RRC connected mode and/or during an initial access procedure. The dynamic updates to the RRC configuration profiles may provide a uniform technique that enables the UE and the network to update any type of RRC configuration profiles (e.g., corresponding to different communication scenarios).

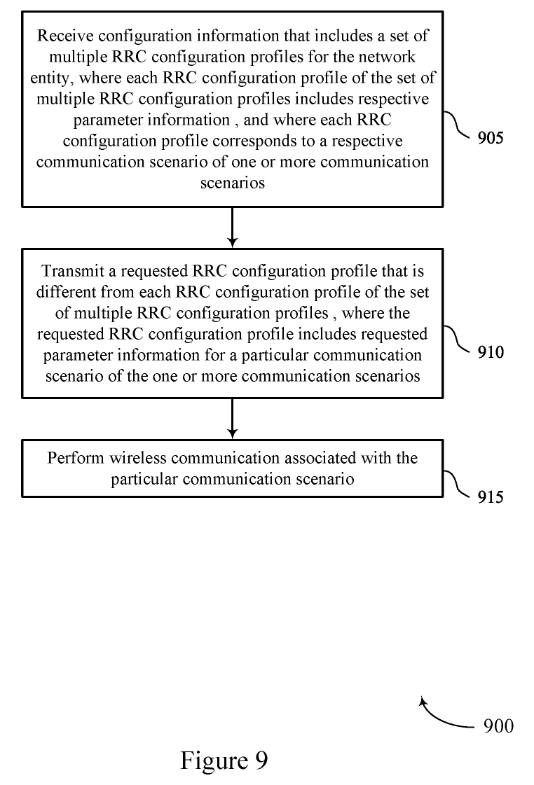

FIG. 9 shows an example of a method 900 that supports AI-native RRC profile adaptation for UE. Operations of the method 900 may be performed by a UE or its components (such as using a processing system configured to cause the UE 115 to perform one or more of the operations) as described herein.

At 905, the method may include receiving configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios. In some examples, aspects of the operations of 905 may be performed by an RRC configuration manager 525.

At 910, the method may include transmitting a requested RRC configuration profile that is different from each RRC configuration profile of the set of multiple RRC configuration profiles, where the requested RRC configuration profile includes requested parameter information for a particular communication scenario of the one or more communication scenarios. In some examples, aspects of the operations of 910 may be performed by an RRC configuration manager 525.

At 915, the method may include performing wireless communication associated with the particular communication scenario. In some examples, aspects of the operations of 915 may be performed by a wireless communication manager 530.

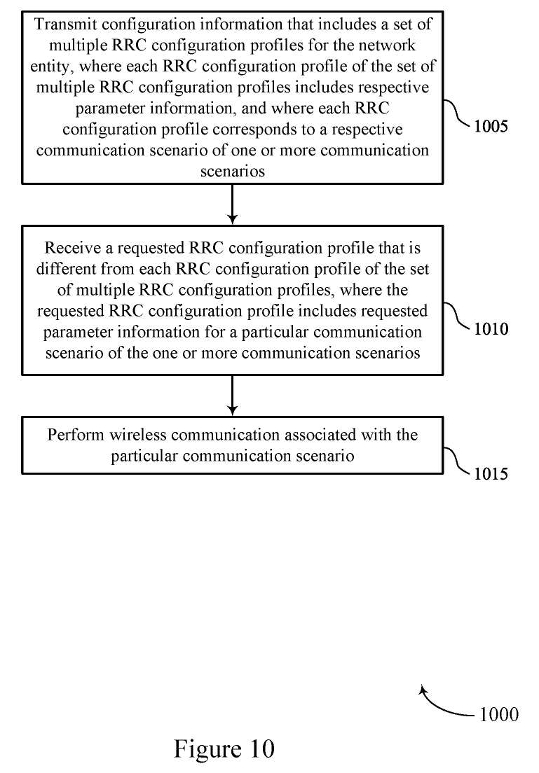

FIG. 10 shows an example of a method 1000 that supports AI-native RRC profile adaptation for UE. Operations of the method 1000 may be performed by a network entity 105 or its components (such as using a processing system configured to cause the network entity to perform one or more operations) as described herein.

At 1005, the method may include transmitting configuration information that includes a set of multiple RRC configuration profiles for the network entity, where each RRC configuration profile of the set of multiple RRC configuration profiles includes respective parameter information, and where each RRC configuration profile corresponds to a respective communication scenario of one or more communication scenarios. In some examples, aspects of the operations of 1005 may be performed by an RRC configuration manager 725.

At 1010, the method may include receiving a requested RRC configuration profile that is different from each RRC configuration profile of the set of multiple RRC configuration profiles, where the requested RRC configuration profile includes requested parameter information for a particular communication scenario of the one or more communication scenarios. In some examples, aspects of the operations of 1010 may be performed by an RRC configuration manager 725.

At 1015, the method may include performing wireless communication associated with the particular communication scenario. In some examples, aspects of the operations of 1015 may be performed by a wireless communication manager 730.

Implementation examples are described in the following numbered clauses:

Aspect 1: A method of wireless communication performed by a network entity, comprising: receiving configuration information that includes a plurality of RRC configuration profiles for the network entity, wherein each RRC configuration profile of the plurality of RRC configuration profiles comprises respective parameter information, and wherein each RRC configuration profile corresponds to a respective communication scenario of one or more communication scenarios; transmitting a requested RRC configuration profile that is different from each RRC configuration profile of the plurality of RRC configuration profiles, wherein the requested RRC configuration profile comprises requested parameter information for a particular communication scenario of the one or more communication scenarios; and performing wireless communication associated with the particular communication scenario.

Aspect 2: The method of aspect 1, wherein transmitting the requested RRC configuration profile comprises: transmitting the requested RRC configuration profile during an initial access procedure of the network entity or during operation of the network entity in a connected mode.

Aspect 3: The method of aspect 2, wherein the requested RRC configuration profile is included in a RACH Msg3, a RACH MsgA, or an RRC signal.

Aspect 4: The method of any of aspects 1 through 3, further comprising: receiving an ACK/NACK message that indicates the requested RRC configuration profile is usable to perform the wireless communication.

Aspect 5: The method of aspect 4, wherein performing the wireless communication comprises: performing, based on the requested RRC configuration profile, the wireless communication.

Aspect 6: The method of any of aspects 4 through 5, wherein each respective parameter information comprises one or more respective indications of parameter values, and the requested parameter information comprises one or more indications of requested parameter values.

Aspect 7: The method of aspect 6, wherein the one or more indications of requested parameter values comprise one or more indications of a range of parameter values.

Aspect 8: The method of any of aspects 1 through 7, wherein the requested parameter information comprises one or more indications of a range of parameter values.

Aspect 9: The method of any of aspects 1 through 8, further comprising: transmitting first information indicative of a reason for transmission of the requested RRC configuration profile.

Aspect 10: The method of aspect 9, wherein the reason for the transmission of the requested RRC configuration profile corresponds to a communication scenario that comprises at least one of: an overheating scenario, an expected traffic pattern scenario of the network entity, a capability of the network entity, an interference scenario, a mobility scenario at the network entity, a C-DRX scenario, or a capability of the network entity.

Aspect 11: The method of any of aspects 9 through 10, wherein transmitting the requested RRC configuration profile and transmitting the first information comprises: transmitting second information, and wherein the second information comprises the requested RRC configuration profile and the first information.

Aspect 12: The method of aspect 11, wherein transmitting the second information comprises: transmitting the second information during an initial access procedure of the network entity or during operation of the network entity in a connected mode.

Aspect 13: The method of aspect 12, wherein the second information is included in a RACH Msg3, a RACH MsgA, or an RRC signal.

Aspect 14: The method of any of aspects 11 through 13, wherein performing the wireless communication comprises: performing, based on the second information, the wireless communication.

Aspect 15: The method of any of aspects 1 through 14, further comprising: transmitting capability information that indicates that the network entity supports a capability to request one or more requested RRC configuration profiles.

Aspect 16: The method of any of aspects 1 through 15, wherein the one or more communication scenarios comprise at least one of: an overheating scenario, an expected traffic pattern scenario of the network entity, an interference scenario, a mobility scenario at the network entity, a C-DRX scenario, or a capability of the network entity.

Aspect 17: The method of any of aspects 1 through 16, further comprising: transmitting first information, wherein the first information comprises an identifier of a particular RRC configuration profile of the plurality of RRC configuration profiles, and an indication to replace the particular RRC configuration profile with the requested RRC configuration profile.

Aspect 18: The method of aspect 17, wherein transmitting the requested RRC configuration profile and transmitting the first information comprises: transmitting second information, and wherein the second information comprises the requested RRC configuration profile and the first information.

Aspect 19: The method of aspect 18, wherein transmitting the second information comprises: transmitting the second information during an initial access procedure of the network entity or during operation of the network entity in a connected mode.

Aspect 20: The method of aspect 19, wherein the second information is included in a RACH Msg3, a RACH MsgA, or an RRC signal.

Aspect 21: The method of any of aspects 18 through 20, wherein performing the wireless communication comprises: performing, based on the second information, the wireless communication.

Aspect 22: The method of any of aspects 1 through 21, wherein transmitting the requested RRC configuration profile comprises: transmitting an indication of the requested RRC configuration profile using one or more resources, or one or more parameters, and wherein the one or more resources, or one or more parameters used to transmit the indication identify the requested RRC configuration profile.

Aspect 23: The method of any of aspects 1 through 22, wherein performing the wireless communication comprises: performing the wireless communication based on one or more metrics that satisfy a threshold condition.

Aspect 24: The method of aspect 23, wherein the one or more metrics correspond to a communication scenario that comprises at least one of: an overheating scenario, an expected traffic pattern scenario at the network entity, an interference scenario, a mobility scenario at the network entity, a C-DRX scenario, or a capability of the network entity.

Aspect 25: The method of any of aspects 1 through 24, wherein performing the wireless communication comprises: performing the wireless communication using the requested RRC configuration profile.

Aspect 26: A method of wireless communication performed by a network entity, comprising: transmitting configuration information that includes a plurality of RRC configuration profiles for the network entity, wherein each RRC configuration profile of the plurality of RRC configuration profiles comprises respective parameter information, and wherein each RRC configuration profile corresponds to a respective communication scenario of one or more communication scenarios; receiving a requested RRC configuration profile that is different from each RRC configuration profile of the plurality of RRC configuration profiles, wherein the requested RRC configuration profile comprises requested parameter information for a particular communication scenario of the one or more communication scenarios; and performing wireless communication associated with the particular communication scenario.

Aspect 27: The method of aspect 26, wherein receiving the requested RRC configuration profile comprises: receiving the requested RRC configuration profile during an initial access procedure associated with the network entity or during operations associated with a connected mode.

Aspect 28: The method of aspect 27, wherein the requested RRC configuration profile is included in a RACH Msg3, a RACH MsgA, or an RRC signal.

Aspect 29: The method of any of aspects 26 through 28, further comprising: transmitting an ACK/NACK message that indicates the requested RRC configuration profile is usable to perform the wireless communication.

Aspect 30: The method of aspect 29, wherein performing the wireless communication comprises: performing, based on the requested RRC configuration profile, the wireless communication.

Aspect 31: The method of any of aspects 29 through 30, wherein each respective parameter information comprises one or more respective indications of parameter values, and the requested parameter information comprises one or more indications of requested parameter values.

Aspect 32: The method of aspect 31, wherein the one or more indications of requested parameter values comprise one or more indications of a range of parameter values.

Aspect 33: The method of any of aspects 26 through 32, wherein the requested parameter information comprises one or more indications of a range of parameter values.

Aspect 34: The method of any of aspects 26 through 33, further comprising: receiving first information indicative of a reason for transmission of the requested RRC configuration profile.

Aspect 35: The method of aspect 34, wherein the reason for the transmission of the requested RRC configuration profile corresponds to a communication scenario that comprises at least one of: an overheating scenario, an expected traffic pattern scenario, a capability, an interference scenario, a mobility scenario, a connected mode-discontinuous reception (C-DRX) scenario, or a capability.

Aspect 36: The method of any of aspects 34 through 35, wherein receiving the requested RRC configuration profile and receiving the first information comprises: receiving second information, wherein the second information comprises the requested RRC configuration profile and the first information.

Aspect 37: The method of aspect 36, wherein receiving the second information comprises: receiving the second information during an initial access procedure of the network entity or during operation associated with a connected mode.

Aspect 38: The method of aspect 37, wherein the second information is included in a RACH Msg3, a RACH MsgA, or an RRC signal.

Aspect 39: The method of any of aspects 36 through 38, wherein performing the wireless communication comprises: performing, based on the second information, the wireless communication.

Aspect 40: The method of any of aspects 26 through 39, further comprising: receiving capability information that indicates support for a capability to request one or more requested RRC configuration profiles.

Aspect 41: The method of any of aspects 26 through 40, wherein the one or more communication scenarios comprise at least one of: an overheating scenario, an expected traffic pattern scenario, an interference scenario, a mobility scenario, a C-DRX scenario, or a capability.

Aspect 42: The method of any of aspects 26 through 41, further comprising: receiving first information, wherein the first information comprises an identifier of a particular RRC configuration profile of the plurality of RRC configuration profiles, and an indication to replace the particular RRC configuration profile with the requested RRC configuration profile.

Aspect 43: The method of aspect 42, wherein receiving the requested RRC configuration profile and receiving the first information comprises: receiving second information, wherein the second information comprises the requested RRC configuration profile and the first information.

Aspect 44: The method of aspect 43, wherein receiving the second information comprises: receiving the second information during an initial access procedure of the network entity or during operation in a connected mode.

Aspect 45: The method of aspect 44, wherein the second information is included in a RACH Msg3, a RACH MsgA, or an RRC signal.

Aspect 46: The method of any of aspects 43 through 45, wherein performing the wireless communication comprises: performing, based on the second information, the wireless communication.

Aspect 47: The method of any of aspects 26 through 46, wherein receiving the requested RRC configuration profile comprises: receiving an indication of the requested RRC configuration profile using one or more resources, or one or more parameters, wherein the one or more resources, or the one or more parameters used to receive the indication identify the requested RRC configuration profile.

Aspect 48: The method of any of aspects 26 through 47, wherein performing the wireless communication comprises: performing the wireless communication based on one or more metrics that satisfy a threshold condition.

Aspect 49: The method of aspect 48, wherein the one or more metrics correspond to a communication scenario that comprises at least one of: an overheating scenario, an expected traffic pattern scenario, an interference scenario, a mobility scenario, a C-DRX scenario, or a capability.

Aspect 50: The method of any of aspects 26 through 49, wherein performing the wireless communication comprises: performing the wireless communication using the requested RRC configuration profile.

Aspect 51: A network entity comprising a processing system that includes a processing system configured to perform a method of any of aspects 1 through 25.

Aspect 52: A network entity comprising at least one means for performing a method of any of aspects 1 through 25.

Aspect 53: A non-transitory computer-readable medium storing code the code comprising instructions executable by one or more processors to perform a method of any of aspects 1 through 25.

Aspect 54: A network entity comprising a processing system configured to perform a method of any of aspects 26 through 50.

Aspect 55: A network entity comprising at least one means for performing a method of any of aspects 26 through 50.

Aspect 56: A non-transitory computer-readable medium storing code the code comprising instructions executable by one or more processors to perform a method of any of aspects 26 through 50.

The methods described herein describe possible implementations, and the operations and the steps may be rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive configuration information that includes a plurality of radio resource control (RRC) configuration profiles for the network entity, wherein each RRC configuration profile of the plurality of RRC configuration profiles comprises respective parameter information, and wherein each RRC configuration profile corresponds to a respective communication scenario of one or more communication scenarios;
transmit a requested RRC configuration profile that is different from each RRC configuration profile of the plurality of RRC configuration profiles, wherein the requested RRC configuration profile comprises requested parameter information for a particular communication scenario of the one or more communication scenarios; and
perform wireless communication associated with the particular communication scenario.

2. The network entity of claim 1, wherein, to transmit the requested RRC configuration profile, the processing system is configured to:
transmit the requested RRC configuration profile during an initial access procedure of the network entity or during operation of the network entity in a connected mode.

3. The network entity of claim 2, wherein the requested RRC configuration profile is included in a random access channel (RACH) message three (Msg3), a RACH message A (MsgA), or an RRC signal.

4. The network entity of claim 1, wherein the processing system is configured to:
receive an acknowledgement/negative-acknowledgement (ACK/NACK) message that indicates the requested RRC configuration profile is usable to perform the wireless communication.

5. The network entity of claim 4, wherein, to perform the wireless communication, the processing system is configured to:
perform, based on the requested RRC configuration profile, the wireless communication.

6. The network entity of claim 4, wherein:
each respective parameter information comprises one or more respective indications of parameter values, and
the requested parameter information comprises one or more indications of requested parameter values.

7. The network entity of claim 6, wherein the one or more indications of requested parameter values comprise one or more indications of a range of parameter values.

8. The network entity of claim 1, wherein the requested parameter information comprises one or more indications of a range of parameter values.

9. The network entity of claim 1, wherein the processing system is configured to:
transmit first information indicative of a reason for transmission of the requested RRC configuration profile.

10. The network entity of claim 9, wherein the reason for the transmission of the requested RRC configuration profile corresponds to a communication scenario that comprises at least one of: an overheating scenario, an expected traffic pattern scenario of the network entity, a capability of the network entity, an interference scenario, a mobility scenario at the network entity, a connected mode-discontinuous reception (C-DRX) scenario, or a capability of the network entity.

11. The network entity of claim 9, wherein, to transmit the requested RRC configuration profile and transmitting the first information, the processing system is configured to:
transmit second information, and wherein the second information comprises the requested RRC configuration profile and the first information.

12. The network entity of claim 11, wherein, to transmit the second information, the processing system is configured to:
transmit the second information during an initial access procedure of the network entity or during operation of the network entity in a connected mode.

13. The network entity of claim 12, wherein the second information is included in a random access channel (RACH) message three (Msg3), a RACH message A (MsgA), or an RRC signal.

14. The network entity of claim 11, wherein, to perform the wireless communication, the processing system is configured to:
perform, based on the second information, the wireless communication.

15. The network entity of claim 1, wherein the processing system is configured to:
transmit capability information that indicates that the network entity supports a capability to request one or more requested RRC configuration profiles.

16. The network entity of claim 1, wherein the one or more communication scenarios comprise at least one of:
an overheating scenario, an expected traffic pattern scenario of the network entity, an interference scenario, a mobility scenario at the network entity, a connected mode-discontinuous reception (C-DRX) scenario, or a capability of the network entity.

17. The network entity of claim 1, wherein the processing system is configured to:
transmit first information, wherein the first information comprises an identifier of a particular RRC configuration profile of the plurality of RRC configuration profiles, and an indication to replace the particular RRC configuration profile with the requested RRC configuration profile.

18. The network entity of claim 17, wherein, to transmit the requested RRC configuration profile and to transmit the first information, the processing system is configured to:
transmit second information, wherein the second information comprises the requested RRC configuration profile and the first information.

19. A network entity for wireless communication, comprising:
a processing system configured to:
transmit configuration information that includes a plurality of radio resource control (RRC) configuration profiles for the network entity, wherein each RRC configuration profile of the plurality of RRC configuration profiles comprises respective parameter information, and wherein each RRC configuration profile corresponds to a respective communication scenario of one or more communication scenarios;
receive a requested RRC configuration profile that is different from each RRC configuration profile of the plurality of RRC configuration profiles, wherein the requested RRC configuration profile comprises requested parameter information for a particular communication scenario of the one or more communication scenarios; and
perform wireless communication associated with the particular communication scenario.

20. A method of wireless communication performed by a network entity, comprising:
receiving configuration information that includes a plurality of radio resource control (RRC) configuration profiles for the network entity, wherein each RRC configuration profile of the plurality of RRC configuration profiles comprises respective parameter information, and wherein each RRC configuration profile corresponds to a respective communication scenario of one or more communication scenarios;
transmitting a requested RRC configuration profile that is different from each RRC configuration profile of the plurality of RRC configuration profiles, wherein the requested RRC configuration profile comprises requested parameter information for a particular communication scenario of the one or more communication scenarios; and
performing wireless communication associated with the particular communication scenario.
